(19) United States
(12) Patent Application Publication
(10) Pub. No.: US 2023/0315512 A1
(43) Pub. Date: Oct. 5, 2023

(54) INFRASTRUCTURE PROVISIONING RUN PRIORITIZATION

(71) Applicant: Scalr, Inc., San Francisco, CA (US)

(72) Inventors: Igor Savchenko, Walnut Creek, CA (US); Sebastian Stadil, Seattle, WA (US)

(21) Appl. No.: 18/130,599

(22) Filed: Apr. 4, 2023

Related U.S. Application Data
(60) Provisional application No. 63/327,136, filed on Apr. 4, 2022.

(51) Int. Cl. G06F 9/48; G06F 9/50

(52) U.S. Cl. CPC G06F 9/4831; G06F 9/5055

(57) ABSTRACT

Methods, systems, and computer program product for managing workspace runs in an information technology (IT) infrastructure is disclosed. In embodiments the IT infrastructure includes one or more workspaces configured for maintaining configurations of API-manageable resources. In various embodiments a method includes determining a run queue that includes two or more runs, each run in the run queue having a prioritization parameter that indicates a first order of runs, determining one or more run queue prioritization factors, and generating a second order of runs based on the one or more run queue prioritization factors. In embodiments runs can then retrieved for execution from the second run queue based on the second order.

### RELATED APPLICATIONS

The present application claims the benefit of U.S. Provisional Patent Application No. 63/327,136, filed Apr. 4, 2022, the disclosure of which is incorporated by reference herein in its entirety.

### TECHNICAL FIELD

The present disclosure relates to information technology systems and, more specifically, to run task prioritization within a computing infrastructure.

### BACKGROUND

Information technology (IT) infrastructure refers generally to the resources and services required for the establishment and operation of an IT environment. IT environments in turn, are then used by an enterprise or other organization to provide IT services to its employees and customers. Resources include hardware, software, and network resources, and can be provided remotely. For example, resources can be provided as Software-as-a-Service (SaaS), Platform-as-a-Service (PaaS), Infrastructure-as-a-Service (IaaS), web application, and the like.

Hardware resources are used to host software resources and include servers, computers, storage, routers, switches, and the like. Software resources include applications that are used by the enterprise or other organization for internal purposes or customer-facing purposes. For example, software resources can include enterprise resource planning (ERP) software applications, customer relationship management (CRM) software applications, productivity software applications, and the like. Network resources include the resources used to provide network connectivity, security, and the like. Remote access to software and hardware resources may be enabled and regulated by the network resources.

Within the IT environment, users can establish one or more workspaces to be available as a configuration of resources within the IT infrastructure. The one or more workspaces each are associated with a configuration file that describes the rules for use of IT infrastructure, and values serving as inputs for the configuration file. The one or more workspaces also reference a state file describing the state of the IT infrastructure. Users can assign various projects to the one or more workspaces where there may be many people working on the same project, such as using a cloud-computing application, or where users work independently on different portions of the project

Improvements to the field of IT infrastructure systems for the establishment and operation of IT environments would be welcome

### SUMMARY

Embodiments of the present disclosure are directed to methods, systems, and computer program product for managing workspace runs in an information technology (IT) infrastructure including one or more workspaces configured for maintaining configurations of API-manageable resources.

Specifically, various embodiments provide benefit in the form of systems, methods and computer program product that address the problems of excessive wait times and run execution inefficiencies in known provisioning systems. For instance, in known provisioning systems, when a provisioning run is requested or generated, it first queued into a run queue where run await execution. In known provisioning systems the runs are simply queued in a first in, first out basis. For example, where there are 1000 provisioning runs queued, when a user queues a 1001st, then the user would have to wait until all 1000 provisioning runs are executed before seeing their run executed. This is especially problematic where the 1000 preceding provisioning runs are development or testing runs, and the 1001st is a mission critical run.

As such, various embodiments are directed to enhancing the processing of workspace runs that, in known systems, are held up because of insufficient parallel computing capacity in a cloud-based infrastructure provisioning system. In various embodiments processing enhancements are achieved via the application of one or more prioritization factors or rules to queued provisioning runs, plans, or applies that allow the user to prioritize the provisioning of the runs, plans, or applies in a provisioning run queue. As a result, various embodiments allow for rules-based prioritization, or manual prioritization of any individual or class of provisioning runs over any other individual or class of provisioning runs.

Accordingly, in various embodiments a method of managing workspace runs includes determining a run queue that includes two or more runs, the runs each including a plan of proposed changes to a configuration of API-manageable resources maintained by a workspace, each run in the run queue having a prioritization parameter that indicates a first order in which the runs are to be executed. In one or more embodiments the method includes determining one or more run queue prioritization factors and receiving a request to prioritize the first order using the one or more run queue prioritization factors, and in response, generating a second order in which the runs in the run queue are to be executed. In various embodiments the method includes retrieving a run for execution from the second run queue based on the second order.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system diagram of an information technology (IT) system, according to one or more embodiments of the disclosure.

FIG. 2 depicts a block diagram of an IT system including IT environments and one or more workspaces, according to one or more embodiments of the disclosure.

FIG. 3 depicts a block diagram of an IT infrastructure controller and run prioritization engine, according to one or more embodiments of the disclosure.

FIG. 4A-4C depicts a block diagram of stages of run prioritization, according to one or more embodiments of the disclosure.

FIG. 5A-5B depicts a block diagram of stages of run prioritization, according to one or more embodiments of the disclosure.

FIG. 6 depicts a method of run prioritization, according to one or more embodiments of the disclosure.

FIG. 7 depicts a method of run prioritization, according to one or more embodiments of the disclosure.

FIG. 8 depicts a method of run prioritization, according to one or more embodiments of the disclosure.

FIG. 9 depicts a method of run prioritization, according to one or more embodiments of the disclosure.

FIG. 10 depicts a method of run prioritization, according to one or more embodiments of the disclosure.

FIG. 11 depicts a logical device including a processor and a computer readable storage unit are depicted, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

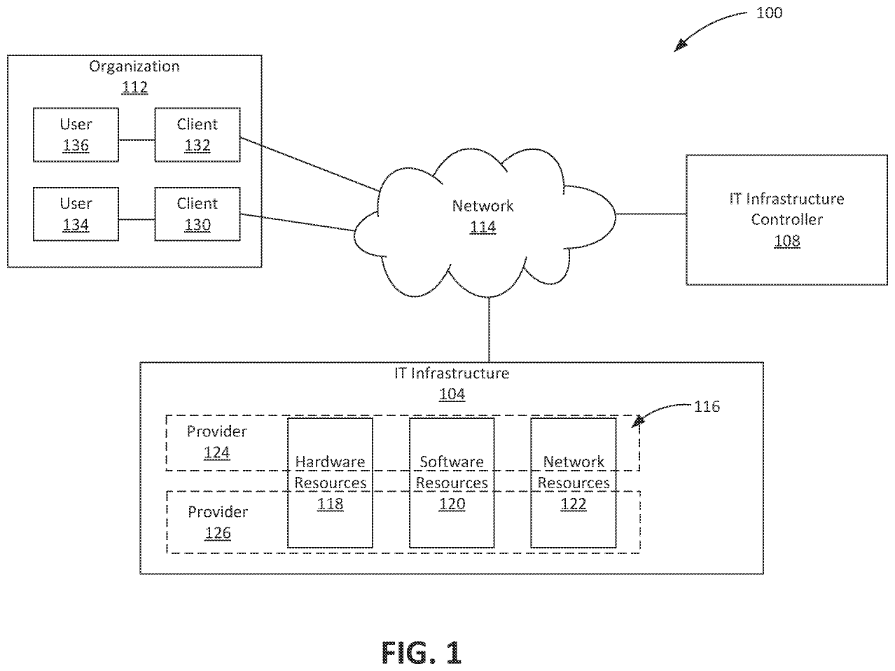

Referring to FIG. 1, an information technology (IT) system 100 is depicted. In various embodiments, the system 100 includes an IT infrastructure 104, an IT infrastructure controller 108, and an organization 112. In one or more embodiments, the IT infrastructure 104, IT infrastructure controller 108, and the organization 112 are communicatively coupled via a network 114 which includes any wired or wireless network including, for example, a local area network (LAN), a wide area network (WAN), a public land mobile network (PLMN), the Internet, and the like.

In various embodiments the IT infrastructure 104 includes a collection of one or more resources 116 including hardware resources 118, software resources 120, and network resources 122. In various embodiments, resources 116 are sourced from or otherwise provided by one or more providers 124, 126. In such embodiments, providers 124, 126 are entities that own or otherwise control access to the resources 116 in the IT infrastructure 104. In some embodiments, providers 124, 126 are private providers such that at least a portion of the resources 116 are owned by the organization 112. In some embodiments, the providers 124, 126 are third party providers that provide access to resources as an infrastructure-as-a-service (IaaS) provider, a platform-as-a-service (PaaS) provider, a software-as-a-service (SaaS) provider, or the like. In such embodiments at least a portion of the resources 116 can be shared amongst multiple organizations. In certain embodiments, the provider(s) 124, 126 can include the organization 112, such as where the organization owns or otherwise controls access to the resources themselves.

In various embodiments, resources 116 are defined or organized into one or more “blocks” that are managed by the system 100 for provisioning or de-provisioning components of the infrastructure 104. For example, depicted in FIG. 1, the infrastructure 104 is organized into a plurality of resource blocks that include a hardware resource 118, a software resource 120, and a network resource 122. In one or more embodiments the blocks can include various information such as arguments, parameters, variables, tags, strings and the like which can be used to configure the resource. For example, the block could include strings indicating the resource type, the resource name, and the provider 124, 126. Further, while the resource blocks depicted in FIG. 1 as being defined by the type of resource (e.g., hardware, software, network), in certain embodiments the blocks could be organized according to a different manner. For example, the block could be organized based on the provider and/or could include including multiple types of resources in a single block.

In one or more embodiments, the IT infrastructure controller 108 is a logical device configured for programmatic control of access to resources 116 via a resource management API or other kind of software. In such embodiments, the controller 108 can create, check, modify, or delete the access to resources 116 for the organization 112 or other entity in the system 100.

For example, in one or more embodiments, based on the IaC instructions the controller 108 generates a plan that describes what the controller 108 will do to reach the desired state of infrastructure indicated by the configuration. The controller 108 can then execute or “apply” the plan to build the described infrastructure. Although in certain embodiments, the execution or application of the generated plan is optional and the controller 108 may simply generate the plan without an apply.

In various embodiments, the IaC instructions can be included within a configuration file. In such embodiments, the configuration file can represent a potential configuration of infrastructure that can be put into effect by the controller 108. For example, in one or more embodiments the configuration file includes resource definitions, environment variables, input variables, and/or other information described using an IaC language. A configuration file can be obtained by a user of a client computer and provided to the controller 108 to provision or de-provision infrastructure resources to match the state of infrastructure described by IaC instructions in the file. In various embodiments, configuration files describe the components needed to run an application, process, or the like. For example, in one or more embodiments the configuration file can be used by the user to provision resources in order to support the deployment, testing, and/or maintenance of a software application, and/or to ensure that the performance of the hosted software satisfies a threshold performance metric, such as a service level objective. In various embodiments, the configuration file can be obtained by a user from a database or registry of existing configuration files or can created by the user or by the organization 112.

In some embodiments, the IT controller 108 can configure the infrastructure 104 using infrastructure as code (IaC) where the infrastructure 104 may be configured via software. For example, in such embodiments the controller 108 can apply one or more configuration files to the IT infrastructure 104 that specify a desired state of the infrastructure 104 as well as one or more corresponding variables. For example, in order to support the deployment, testing, and/or maintenance of a software application, the IT infrastructure 104 may be configured based on a configuration file created, for example, by the organization 112 to provision, modify, and/or de-provision the one or more resources 116 to host the software application.

In one or more embodiments, the organization 112 is a unit for and grouping clients, users, and the like, together and for controlling the group's access to resources 116 in the IT infrastructure 104. In various embodiments, the organization 112 can represent an enterprise or a sub-group within the enterprise, such as a business unit within the company. As shown in FIG. 1, the organization 112 can include one or more clients 130, 132, along with one or more associated users 134, 136 that interact with the system 100. Further, it should be appreciated that while FIG. 1 depicts a single organization 112, additional organizations, clients, and users may be included in the system 100.

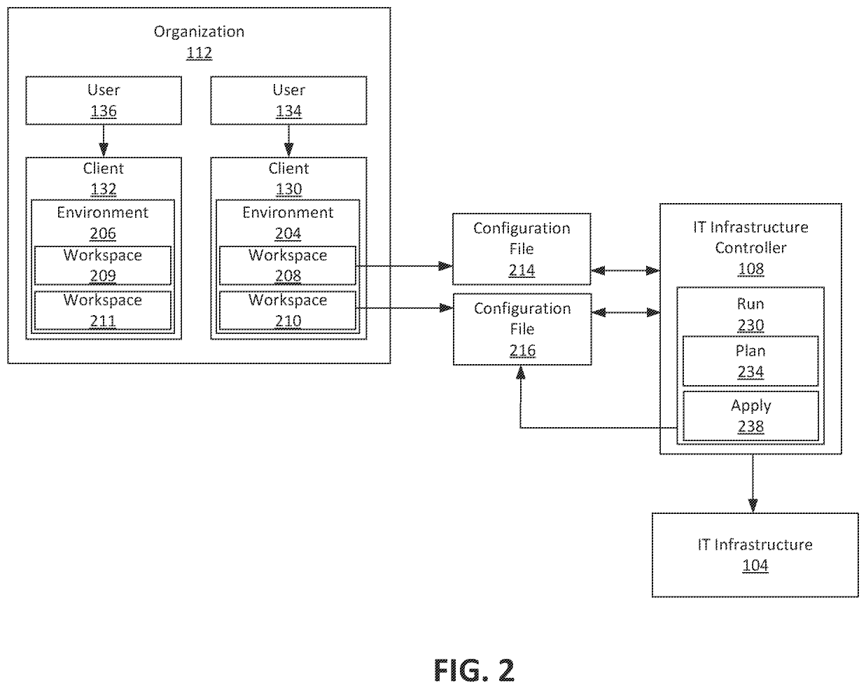

Referring to FIG. 2, a block diagram of the organization 112 and IT environments 204, 206 is depicted, according to one or more embodiments. In various embodiments, the environment 200 includes an organization 112 grouping together one or more clients 130, 132 each associated with one or more users 134, 136. In various embodiments the clients 130, 132 each includes an IT environment 204 which includes one or more workspaces 208. In one or more embodiments each workspace 208-211 is associated with a configuration file. For example a first workspace 208 is associated with a first configuration 214 and a second workspace 210 is associated with a second configuration 216. For clarity, configuration files associated with workspaces 209, 211 are omitted from FIG. 2. As described above, the configuration 214, 216 is a file that specifies a desired state of the infrastructure 104 as well as one or more corresponding variables at a specific moment in time.

In one or more embodiments, a workspace is a unit for grouping a configuration of resources that is planned to be provisioned or has been provisioned by the controller 108. In such embodiments, the planned or provisioned configuration of resources occurs within a workspace, and each workspace contains everything necessary to manage a given collection of infrastructure. For instance, in various embodiments the workspace contains configuration information including a configuration file and one or more state files. As described above, a configuration file is a file including IaC instructions representing a potential configuration of infrastructure that can be put into effect by the controller 108. For example, in one or more embodiments the configuration file includes resource definitions, environment variables, input variables, and/or other information described using an IaC language. A configuration file can be obtained by a user of a client computer and provided to the controller 108 to provision or de-provision infrastructure resources to match the state of infrastructure described by IaC instructions in the file. In various embodiments the configuration file can be obtained, inputted, or initialized from a configuration database of existing configuration files or can created as a new file by the user or by the organization 112.

In various embodiments, state files serve as a “source of truth” for the workspace by including information that indicates a current state of infrastructure 104 including the resources corresponding to each workspace. For example, in various embodiments the system stores the IDs and properties of the resources it manages for the workspace in the state file, so that it can update or destroy those resources going forward. As such, the state file functions as a reference point for making changes to infrastructure 104 to match a configuration described in the configuration file.

In or more embodiments, this configuration information is maintained by the system and then is used whenever it executes an operation in the context of that workspace. For example, to further modify the infrastructure to provision or deprovision resources in that workspace. As such, in various embodiments the workspace will produce specific runs, including plans and/or applies, that are specific to each workspace. In one or more embodiments, each workspace retains backups or a database of configuration information. For example, in various embodiments the workspace includes a state file database including some or all previous state files associated with the workspace. For example, the state file database can be useful for tracking changes to the workspace over time or recovering from problems. In certain embodiments, the workspace includes a run history database that includes a record of all run activity, including one or more of summaries, logs, a reference to the changes that caused the run, and user comments.

In one or more embodiments each workspace 208-211 is associated with a configuration file. For example, a first workspace 208 is associated with a first configuration 214 and a second workspace 210 is associated with a second configuration 216. For clarity, configuration files associated with workspaces 209, 211 are omitted from FIG. 2. As described above, the configuration 214, 216 is a file that specifies a desired state of the infrastructure 104 as well as one or more corresponding variables at a specific moment in time.

In one or more embodiments the IT infrastructure controller 108 is configured to perform one or more operations to provision, modify, and/or de-provision resources at the infrastructure 104 in order to apply the configurations 214, 216 associated with the workspaces. As such, in various embodiments the creation or modification of the configuration files 214, 216 is the process by which infrastructure 104 is provisioned, de-provisioned, modified, or the like. In various embodiments, this process is referred to as a “Run”. Performing a run to make modifications to the configuration files 214, 216 is expected such as when new configurations need to be added to the environment or when existing configurations need to be modified. In various embodiments the IT infrastructure controller 108 is configured to generate or plan the runs, thereby modifying or creating proposed changes to the configuration which, in some embodiments, are then executed by the controller 108 to in turn modify the infrastructure 104.

Depicted in FIG. 2, and described further below, a run 230 is depicted stored in the memory of the IT infrastructure controller 108. In various embodiments the run 230 may be in the process of being executed by the controller 108 or may be awaiting execution. For example, the run 230 may be awaiting execution along with one or more additional runs 230 stored in the memory of the controller 108. Described further below, in such embodiments the runs 230 awaiting execution may be placed into one or more run queues where each run 230 is assigned a prioritization parameter that indicates the order in which the runs in the queue are to be executed. In one or more embodiments a run 230 can include a number of sub-elements or stages. For example, depicted in FIG. 2 the run 230 includes a plan 234 and an apply 238. However, in certain embodiments the run 230 could include fewer or more elements. For example, in some embodiments, the run 230 could include only the plan 234 and not include the apply 238.

In one or more embodiments the plan 320 includes a plan file including declarative language describing proposed changes to the configuration 216. In various embodiments, the plan file is created by comparing the infrastructure state to a proposed configuration and proposed variables, and determining which changes are necessary to make the state match the proposed configuration. The plan file thus describes the changes deemed necessary using declarative language which can be applied by the IT infrastructure controller 108. In one or more embodiments, the apply 238 includes carrying out the changes declared by the plan 234 and applying the changed configuration to the infrastructure 104. In various embodiments, this includes provisioning and/or de-provisioning some or all resources accessible by the workspace 210. In some embodiments, the apply stage 328 can be automatically executed subsequent to the plan stage 320. However, in other embodiments, the apply stage 328 can wait for approval or feedback to perform the apply.

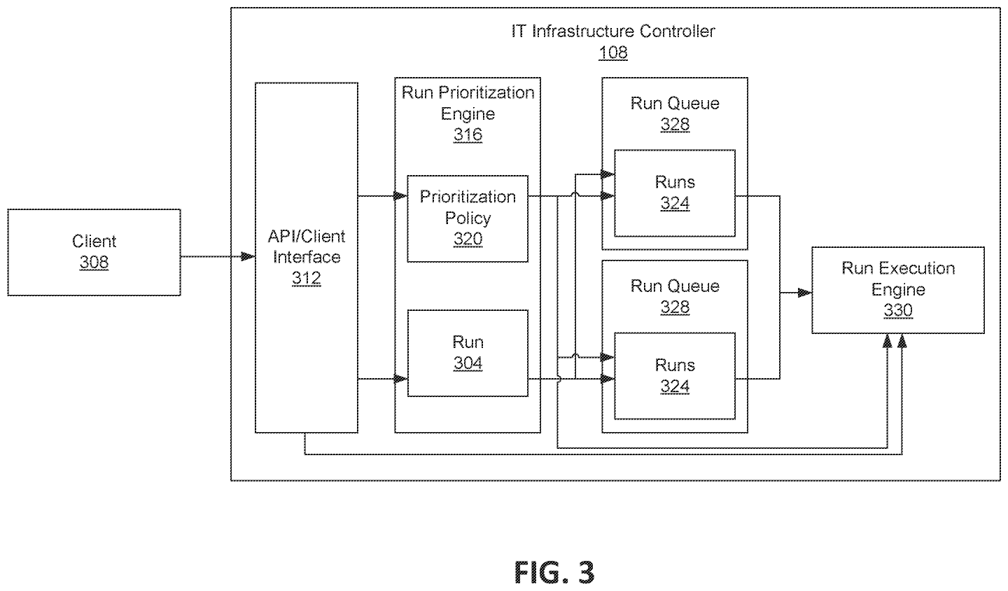

Referring to FIG. 3, a block diagram of an IT infrastructure controller is depicted. Specifically, FIG. 3 depicts a block diagram of run prioritization and execution, according to one or more embodiments. In one or more embodiments, the IT infrastructure controller 108 can create or order a run 304. As described, the run 304 can include the number of elements or actions including a plan phase where the controller 108 can assemble various inputs to generate an infrastructure plan that, if applied in an apply phase, produces a set of technical changes to the infrastructure to conform with the infrastructure plan. In various embodiments, the run 304 is originated via a client computer 308 who can interface with the controller 108 via an API 312.

In various embodiments, after being generated the run 304 is received by a run prioritization engine 316. In various embodiments the prioritization engine 316 is a software application of the controller 108 that functions to enhance the processing of workspace runs that by prioritizing certain runs to compensate for computing limitations/parallel processing capacity in the infrastructure controller 108. Thus, in one or more embodiments the run prioritization engine 316 is configured to prioritize existing runs 324 within one or more run queues 328 and/or place a new run 304 into the one or more run queues 328. In such embodiments, the run prioritization engine 316 allows the controller 108 to process/execute runs according to methods beyond merely a first in, first out basis.

For example, in embodiments processing enhancements are achieved via the application of a prioritization policy 320 that includes one or more factors or rules for queuing runs that allow the user to prioritize the provisioning of the runs in a run queue. As a result, various embodiments allow for rules-based prioritization, or manual prioritization, of any individual run or class of run over any other run. In one or more embodiments, a client computer 308 can configure the run prioritization engine 316 by adding, modifying, or removing rules to/from the prioritization policy 320. In various embodiments the run prioritization engine 316 can be triggered to initiate a prioritization or reprioritization of queued runs 324 and/or the run queues 328 in response to receiving a new run 304 to add into the one or more run queues 328. Similarly, in various embodiments the run prioritization engine 316 can be triggered to initiate a prioritization or reprioritization in response to the modification of the prioritization policy 320. Upon being triggered, the run prioritization engine will then modify the order of some, or all run tasks in the one or more run queues 328 based on the new policy 320 and/or to include the new run 304. In certain embodiments the client 308 can manually trigger prioritization upon a client request. For example, in one or more embodiments, the client 308 can trigger the run execution engine 330 to execute a specific run from the one or more run queues. In certain embodiments, the run execution engine 330 can be configured to select specific runs from the run queues 328. For example, in certain embodiments, rather than being fed runs from the run queue 328 in a manner dictated by the order of the runs 324 in the queues 324 the run execution engine 330 will automatically pull certain runs out of the run queue 328 on its own. For example, in certain embodiments the client 308 can order the execution engine 330 via the client interface 312 to retrieve a specific run for immediate execution. In some embodiments, the execution engine 330 can reference rules in the prioritization policy 330 to select certain runs for immediate execution over other types or classes of runs. For instance, in some embodiments the prioritization policy 330 could indicate that mission critical runs should be assigned a higher priority than development or testing runs. The execution engine 330, referencing that policy, will automatically pull mission critical runs from the run queue while leaving development or testing runs in the run queue to be governed by the remaining order of runs within the run queue 328.

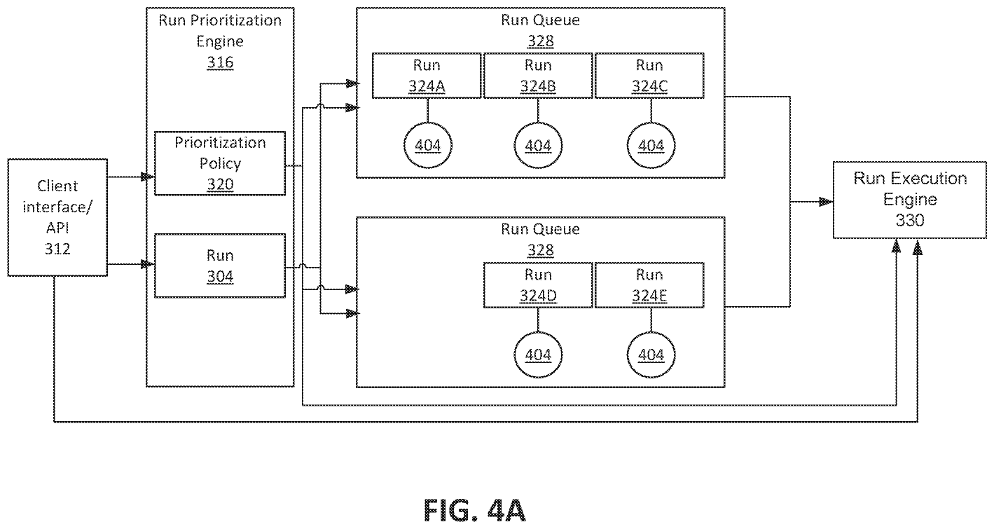

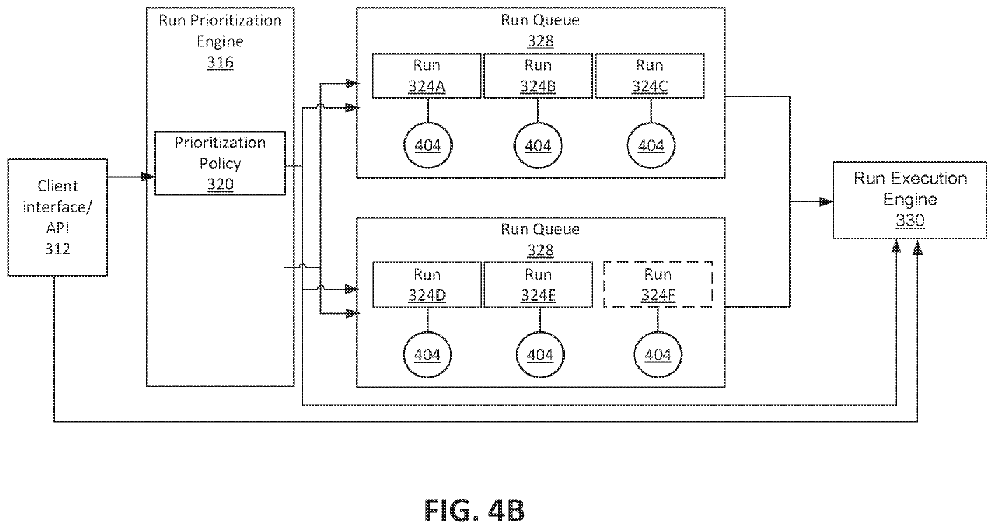

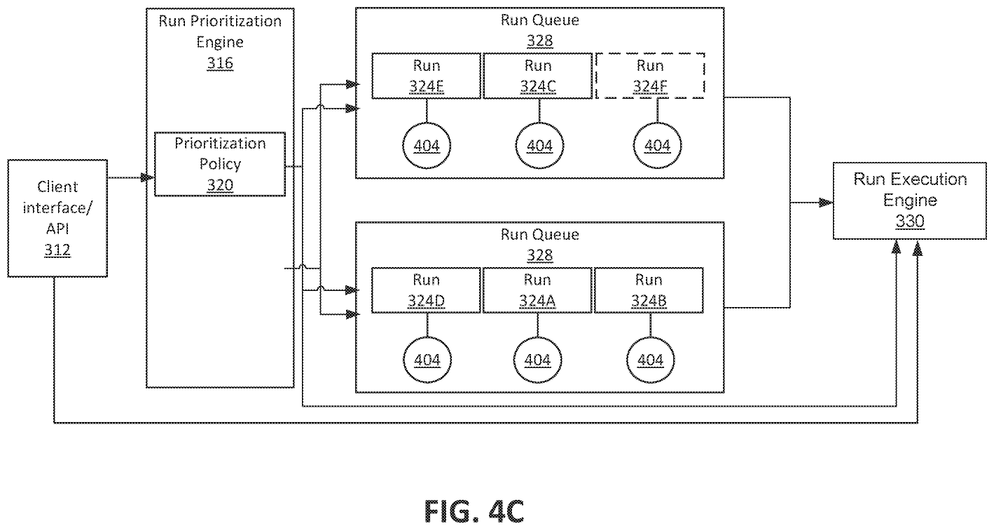

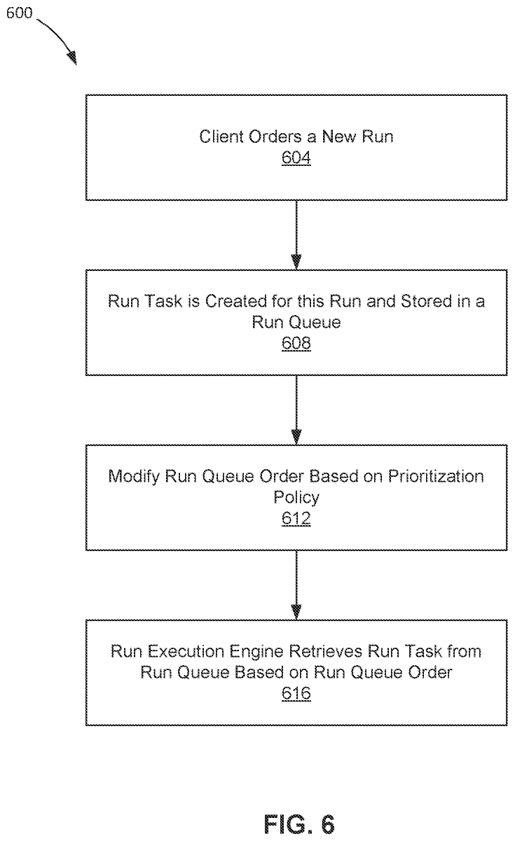

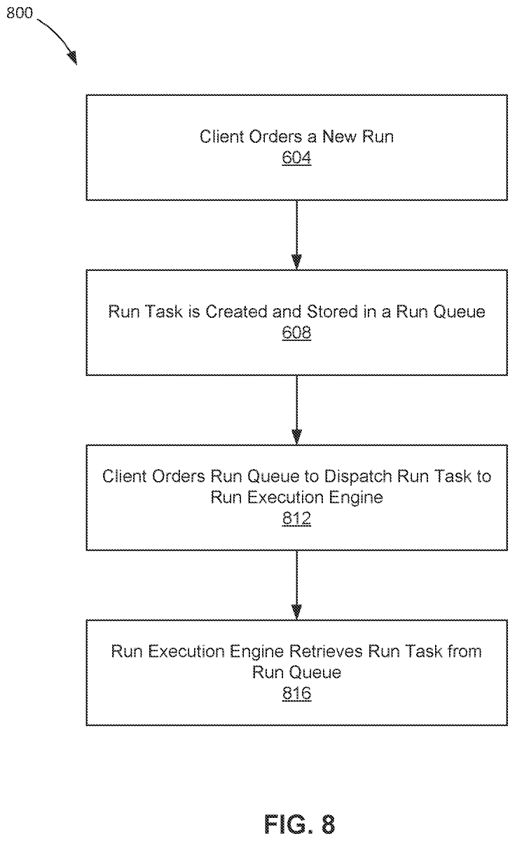

Referring to FIGS. 4A-4C a block diagram depicts stages of run prioritization via the run prioritization engine, according to one or more embodiments of the disclosure. In addition, the FIGS. 4A-4C depict various stages in conjunction with various methods 600, 700, 800 of run prioritization depicted in FIGS. 6-8.

Referring specifically to FIG. 4A, and FIGS. 6-8, the block diagram depicts an initial state of run prioritization where a newly ordered run 304 has been received by the run prioritization engine 316 for placement into the one or more run queues 328. In various embodiments, methods 600, 700, 800 each include operations 604-608, where the methods include a client ordering a new run and a run task is created for the ordered run and is placed or stored in a run queue 328.

In various embodiments, each of the run queues 328 includes one or more runs 324A-324E which in turn are each assigned a prioritization parameter 404. In one or more embodiments the prioritization parameter 404 is a value or other indicator that corresponds to a run and assigns a priority to the assigned runs relative to one or more other runs in the run queue 328. For example, run 324A has a prioritization parameter 404 which indicates a relative priority for compared to runs 324B and 324C in their run queue 328. In certain embodiments, the prioritization parameter 404 indicates a global priority such that a relative priority is indicated as compared to all other runs in memory of the IT controller 108. For example, in such embodiments run 324A has a prioritization parameter which indicates a relative priority for compared to runs 324B and 324C in their run queue 328 and also a relative priority to runs 324D, 324E in the other run queue 328. Depicted in FIG. 4B the new run is placed within one or more of the run queues 328 as run 324F and is assigned a prioritization parameter 404. In various embodiments, the run queues 328 can be described as having an “order” or arrangement of the runs within the run queue where the prioritization parameters 404 for each of the runs indicate an order of relative priority. For example, in FIG. 4B the runs 324A-324F are arranged in a first order of runs based on the prioritization parameters 404.

Referring specifically to FIGS. 4C and 6, the method 600 includes, at operation 612, modifying the run queue order based on the prioritization policy. In such embodiments the run prioritization engine 316 can modify or reprioritize the order of the run queues 328 to produce a second order of runs 324A-324F. Similarly, in various embodiments the run prioritization parameters 404 for each of the runs can be altered to correspond with the new order and new relative priority of runs based on the rules set forth in the prioritization policy 320. In various embodiments, at operation 616, the run execution engine 330 retrieves the run from the run queue based on the run order indicated by the parameters 404.

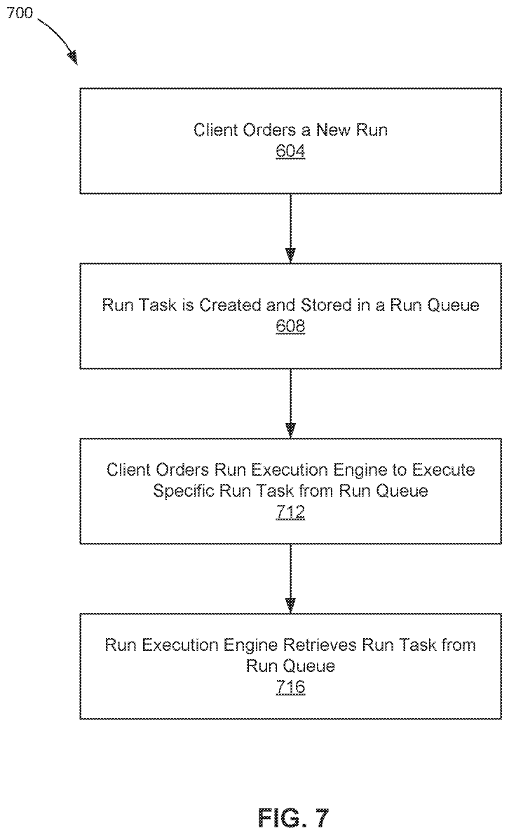

In certain embodiments the client 308, via the client interface 312, can order the execution engine 330 to retrieve a specific run for immediate execution. For example, referring to FIG. 7, at operations 712-716, the method 700 includes ordering the run execution engine 330 to execute a specific run task from the run queue and the run execution engine retrieving the specified run task from the run queue. Similarly In some embodiments the client, via the client interface 312, can select a run task from the run queue and manually input a different priority parameter than assigned priority number, or inputs a different queue number than the assigned queue number. In such embodiments the run prioritization engine then sorts all run tasks in the one or more run queue using the prioritization policy and using the manually set priority number for the run task. In some embodiments the client, via the client interface 312 can indicate a specific run queue for placement of the run task. For example, in various embodiments the specified run task could be moved from a first run queue to a second run queue.

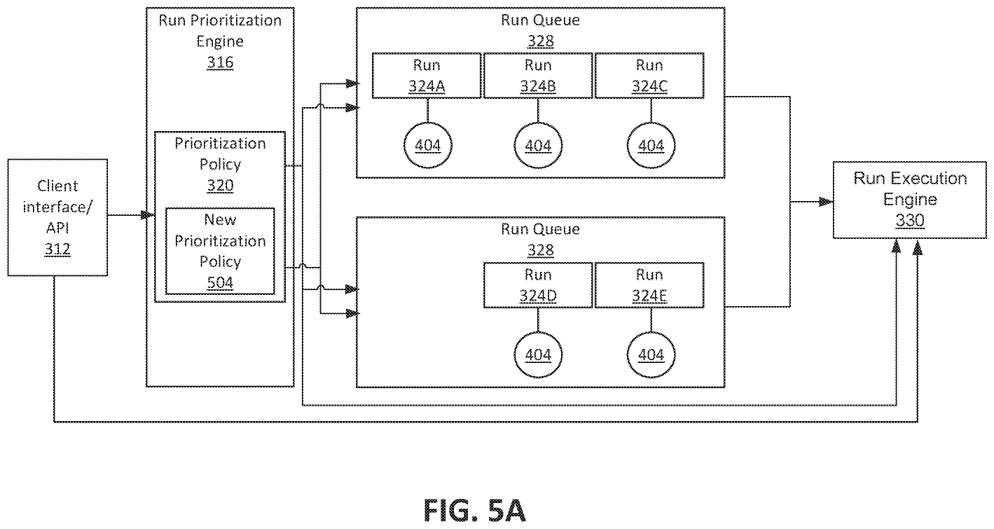

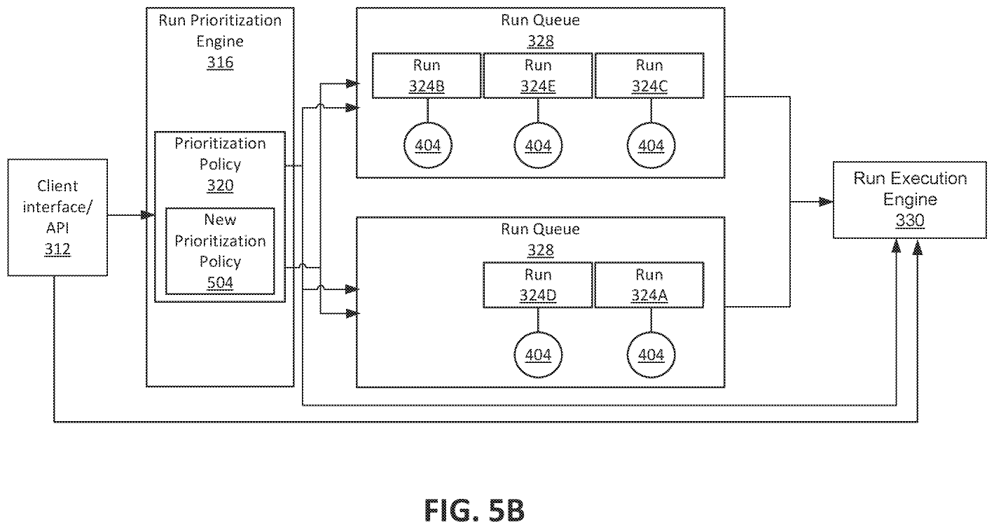

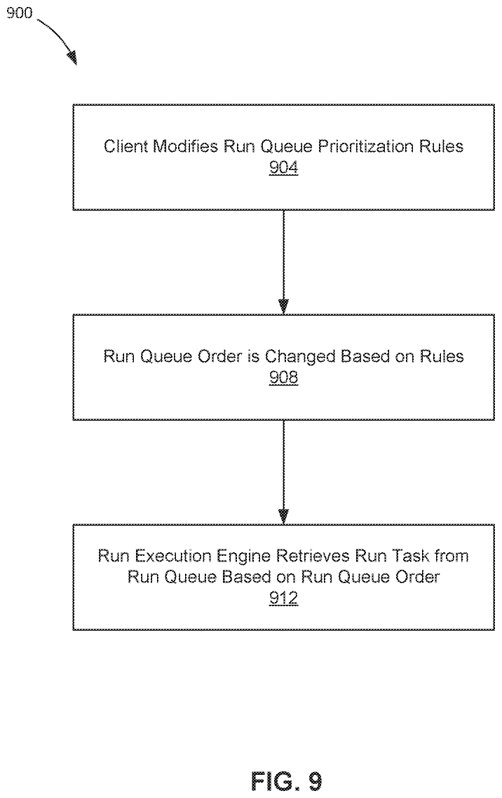

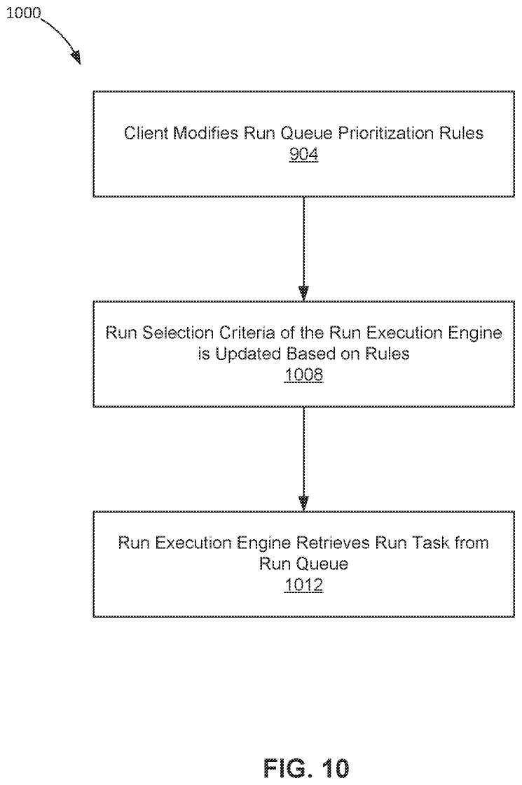

Referring to FIGS. 5A-5B a block diagram depicts stages of run prioritization via the run prioritization engine, according to one or more embodiments of the disclosure. In addition, the FIGS. 5A-5B depict various stages in conjunction with various methods 900, 1000 of run prioritization depicted in FIGS. 9-10. Referring specifically to FIG. 5A, and FIGS. 9-10, the block diagram depicts an initial state of run prioritization where a new prioritization policy 504 has been received by the run prioritization engine 316 for placement. In various embodiments, methods 900, 1000 each include operation 904 where the methods include a client modifying the run queue prioritization rules/policy. In various embodiments, based on the new prioritization policy 504, at operation 908 the run queue order is then triggered to prioritize the order of the run queues 328 based on the additional or modified rule set. For example, at operation 908-912, in various embodiments the method 900 includes changing the run queue order based on the modified prioritization rules and the run execution engine retrieving a run task from the run queue based on the new run queue order. In certain embodiments, where the rune execution engine 330 is configured to select run tasks from the run queue based on the prioritization policy 320, once the new policy 504 is incorporated the run execution engine accordingly updates its run selection criteria. For example, at operations 1008-1012 in various embodiments the method 1000 includes updating the run selection criteria based on the modified prioritization rules and the run execution engine retrieving a run task from the run queue based on the new criteria.

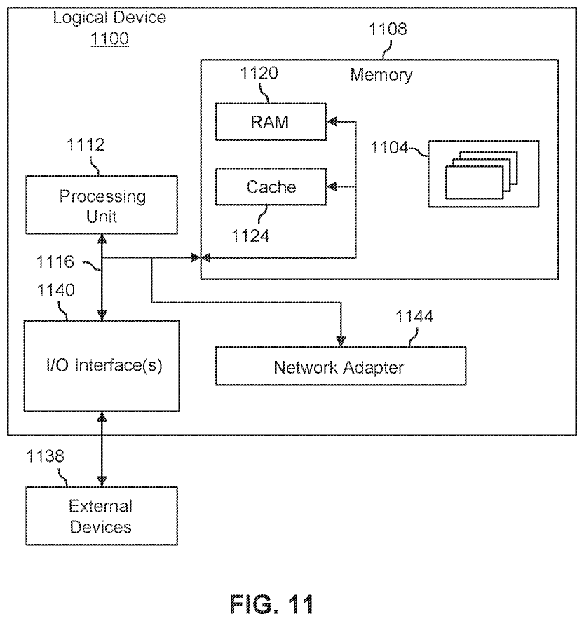

Referring to FIG. 11, a logical device 1100 including a processor and a computer readable storage unit are depicted, according to one or more embodiments of the disclosure. In various embodiments, logical 800 is for use in IT management system for executing various embodiments of the disclosure as described above. For example, and as described herein, logical device 1100 can be configured to execute and/or store various program instructions as a part of a computer program product. Logical device 1100 may be operational with general purpose or special purpose computing system environments or configurations, such as the systems described according the embodiments herein.

Examples of computing systems, environments, and/or configurations that may be suitable for use with logical device 1100 include, but are not limited to, personal computer systems, server computer systems, handheld or laptop devices, multiprocessor systems, mainframe computer systems, distributed computing environments, and the like.

Logical device 1100 may be described in the general context of a computer system, including executable instructions, such as program modules 1104, stored in system memory 1108 being executed by a processor 1112. Program modules 1104 may include routines, programs, objects, instructions, logic, data structures, and so on, that perform particular tasks or implement particular abstract data types. Program modules 1104 may be practiced in distributed computing environments where tasks are performed by remote processing devices that are linked through a network. In a distributed computing environment, program modules 1104 may be located in both local and remote computer system storage media including memory storage devices. As such, in various embodiments logical device 1100 can be configured to execute various program modules 1104 or instructions for executing various embodiments of the disclosure. For example, in various embodiments logical device 1100 can be configured to execute a run or a policy run to generate proposed changes to a configuration or to modify polices in a policy group associated with a workspace.

The components of the logical device 1100 may include, but are not limited to, one or more processors 1112, memory 1108, and a bus 1116 that couples various system components, such as, for example, the memory 1108 to the processor 1112. Bus 1116 represents one or more of any of several types of bus structures, including, but not limited to, a memory bus and/or memory controller, a peripheral bus, and a local bus using a suitable of bus architecture.

In one or more embodiments, logical device 1100 includes a variety of computer readable media. In one or more embodiments, computer readable media includes both volatile and non-volatile media, removable media, and non-removable media.

Memory 1108 may include computer readable media in the form of volatile memory, such as random access memory (RAM) 1120 and/or cache memory 1124. Logical device 1100 may further include other volatile/non-volatile computer storage media such as hard disk drive, flash memory, optical drives, or other suitable volatile/non-volatile computer storage media. As described herein, memory 1108 may include at least one program product having a set (e.g., at least one) of program modules 1104 or instructions that are configured to carry out the functions of embodiments of the disclosure.

Logical device 1100 may also communicate with one or more external devices 1138 such as other computing nodes, a display, keyboard, or other I/O devices, via an I/O interface(s) 1140 for transmitting and receiving sensor data, instructions, or other information to and from the logical device 1100. In one or more embodiments, I/O interface 1140 includes a transceiver or network adaptor 1144 for wireless communication. As such, in one or more embodiments, I/O interface 1140 can communicate or form networks via wireless communication.

One or more embodiments may be a computer program product. The computer program product may include a computer readable storage medium (or media) including computer readable program instructions for causing a processor to enhance target intercept according to one or more embodiments described herein. The computer readable storage medium is a tangible device that can retain and store instructions for use by an instruction execution device. The computer readable storage medium may be, for example, an electronic storage device, a magnetic storage device, an optical storage device, or other suitable storage media.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Program instructions, as described herein, can be downloaded to respective computing/processing devices from a computer readable storage medium or to an external computer or external storage device via a network, for example, the Internet, a local area network, a wide area network and/or a wireless network. A network adapter card or network interface in each computing/processing device may receive computer readable program instructions from the network and forward the computer readable program instructions for storage in a computer readable storage medium within the respective computing/processing device.

Computer readable program instructions for carrying out one or more embodiments, as described herein, may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a single computer, or partly on the single computer and partly on a remote computer. In some embodiments, the computer readable program instructions may execute entirely on the remote computer. In the latter scenario, the remote computer may be connected to the single computer through any type of network, including a local area network (LAN) or a wide area network (WAN), or public network.

One or more embodiments are described herein with reference to flowchart illustrations and/or block diagrams of methods, systems, and computer program products according to one or more of the embodiments described herein. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the method steps discussed above, or flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The method steps, flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some embodiments, the functions noted in the block may occur out of the order noted in the figures. For example, two blocks shown in succession may in fact, be executed substantially concurrently, or the blocks may sometimes be executed in the reverse order, depending upon the functionality involved.

In one or more embodiments, the program instructions of the computer program product are configured as an “App” or application executable on a laptop or handheld computer utilizing a general-purpose operating system. As such, in various embodiments can be implemented on a handheld device such as a tablet, smart phone, or other device.

In various embodiments, the code/algorithms for implementing one or more embodiments are elements of a computer program product, as described above, as program instructions embodied in a computer readable storage medium. As such, such code/algorithms can be referred to a program instruction means for implementing various embodiments described herein.

In addition, to the above disclosure, the following U.S. patents and patent Publications are hereby incorporated by reference: U.S. Pat. Nos. 10,999,162; 11,223,526; 2022/0078228; 2020/0183707; 2020/0183739; 2020/0183754; 2021/0328864; 2021/0359920; and 2022/0014427.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method of managing workspace runs in an information technology (IT) infrastructure including one or more workspaces configured for maintaining configurations of API-manageable resources, the method comprising:
receiving a request to execute a run, the run including a plan of proposed changes to a configuration of API-manageable resources maintained by a workspace;
determining a run queue that includes two or more runs each having a prioritization parameter that indicates a first order in which the runs are to be executed;
determining one or more run queue prioritization factors; and
in response to the request from the user to execute the run, applying the one or more run queue prioritization factors to the first order to generate a second order from the first order, wherein the second order includes the requested run; and
retrieving a run for execution from the run queue based on the second order.

2. The method of claim 1, wherein the one or more run queue prioritization factors includes one or more of a run type and a source of the run.

3. The method of claim 1, wherein the one or more run queue prioritization factors includes a predetermined order including a first in first out order and a last in last out order.

4. The method of claim 1, wherein the one or more run queue prioritization factors includes predetermined prioritization parameter for the run.

5. The method of claim 4, wherein the predetermined prioritization parameter indicates that the run is first to be executed in the second order.

6. A method of managing workspace runs in an information technology (IT) infrastructure including one or more workspaces configured for maintaining configurations of API-manageable resources, the method comprising:
determining a run queue that includes two or more runs, the runs each including a plan of proposed changes to a configuration of API-manageable resources maintained by a workspace, each run in the run queue having a prioritization parameter that indicates a first order in which the runs are to be executed;
determining one or more run queue prioritization factors;
receiving a request to prioritize the first order using the one or more run queue prioritization factors, and in response, generating a second order in which the runs in the run queue are to be executed; and
retrieving a run for execution from the second run queue based on the second order.

7. The method of claim 6, wherein the one or more run queue prioritization factors includes one or more of a run type and a source of the run.

8. The method of claim 6, wherein the one or more run queue prioritization factors includes a predetermined order for the second run queue, the predetermined order including a first in first out order, and a last in last out order.

9. The method of claim 6, wherein the one or more run queue prioritization factors includes predetermined prioritization parameter for the run.

10. The method of claim 9, wherein the predetermined prioritization parameter indicates that the run is first to be executed in the second run queue.

11. A method of managing workspace runs in an information technology (IT) infrastructure including one or more workspaces configured for maintaining configurations of API-manageable resources, the method comprising:
determining a run queue that includes two or more runs each including a plan of proposed changes to a configuration of API-manageable resources maintained by a workspace, each run having a prioritization parameter that indicates a first order in which the runs are to be executed;
determining one or more run queue prioritization factors for the run queue;
receiving, from a user, a modification to the one or more run queue prioritization factors;
in response to the modification, generating a second order by applying the one or more run queue prioritization factors to the first order of runs; and
retrieving a run for execution from the run queue based on the second order.

12. The method of claim 11, wherein the one or more run queue prioritization factors includes one or more of a run type and a source of the run.

13. The method of claim 11, wherein the one or more run queue prioritization factors includes a predetermined order for the second run queue, the predetermined order including a first in first out order, and a last in last out order.

14. The method of claim 11, wherein the one or more run queue prioritization factors includes predetermined prioritization parameter for the run.

15. The method of claim 14, wherein the predetermined prioritization parameter indicates that the run is first to be executed in the run queue.
